(19) United States
(12) Patent Application Publication
(10) Pub. No.: US 2016/0365729 A1
(43) Pub. Date: Dec. 15, 2016

(54) INTELLIGENT CONTROL SYSTEM FOR POWER GENERATION EQUIPMENT

(71) Applicant: Tanachat Pochana, Bangkok (TH)

(72) Inventor: Tanachat Pochana, Bangkok (TH)

(21) Appl. No.: 15/168,720

(22) Filed: May 31, 2016

Related U.S. Application Data
(60) Provisional application No. 62/173,425, filed on Jun. 10, 2015.

(51) Int. Cl. H02J 3/38; G05B 13/02; H04L 29/08

(52) U.S. Cl. CPC H02J 3/38; H04L 67/12; G05B 13/021

(57) ABSTRACT

An intelligent interactive power management control system for power generation equipment, which provides for information to be exchanged in such a way that equipment control units can be made to operate according to a configurable way that may vary over time and according to the environment and available power within a power generation system to save energy costs and increase safety.

### RELATED PATENT APPLICATION

This application claims the benefit of U.S. Provisional Patent Application No. 62/173,425 filed Jun. 10, 2015 entitled INTELLIGENT CONTROL SYSTEM FOR POWER SUPPLY EQUIPMENT and which is hereby incorporated herein by reference in the entirety.

### FIELD OF THE INVENTION

The present invention is related to an intelligent control system consisting of a main control unit, and equipment control units such as solar control units, wind control units, engine generator control units and battery backup control units that provide for constant power measurement and information to be exchanged with the control units in such a way that they can be made to operate according to a configurable power plan that may vary over time and according to changing tariff rules and the current power supply and consumption situation to achieve optimum power delivery to the customer, saving energy costs and increasing power safety.

### BACKGROUND

A lot of ingenuity has been channeled recently into finding ways to use alternative energy equipment more efficiently in order to better supplement or replace traditional electric power supplied from the electricity providers.

Many local and small scale power generation solutions are now available such as photovoltaic solar panels and wind turbines that can deliver electric power under specific conditions with each having their intrinsic limitations. Such power generation systems can be installed locally at a customer site and be made to operate in conjunction with the traditional electric power supply reducing the customer consumption from the electric power grid or even replacing it altogether. Furthermore, in cases where the customer power consumption at a certain time is less than the available power being generated and if the electricity company allows it, some systems offer the possibility to transfer surplus power from the customer's power generation system into the electric power grid.

The manufacturers of the power generation products typically offer a control unit able to monitor the correct operation of the specific type of equipment, to synchronize it to the electric power grid and in some cases to manage the power transfer into the electric power grid if this is allowed. Some control units provide reports that can be accessed locally or through the internet. All these functionalities are however in virtually all cases limited to use only with the specific power generation product or only to products manufactured by the same manufacturer. An integrated solution to allow the power generation equipment to operate with other existing equipment or power generation equipment from different manufacturers is not available.

Another shortcoming within the local or small scale power generation market is the ability of the control units to adapt the operation of the equipment according to a variable set of rules that take into consideration the cost of the grid power as well as the time of day, seasonal usage and other custom conditions to efficiently distribute power and produce custom reports on effective power savings. More detailed and specific reports can be used to support financial investment to fund other local and small scale power generation projects.

These shortcomings create difficulties to find an efficient and cost effective solution to be implemented that can be financed and as a result, most residential and industrial customers have not yet decided to purchase alternative energy power equipment.

### Prior Art

Control units are available from the power generation manufactures of specific power production equipment and are normally designed to operate only with that intended equipment. In some cases some flexibility is available, allowing a control unit to operate also with similar equipment from competitors, for example allowing diesel generators from different manufactures to be controlled from a single control unit.

Some control units of the prior art allow the synchronization of the power generated locally with the power supplied by the electric power grid. If an attachment to supply power to the electric power grid is available and if there is agreement with the electric power company, the available locally generated power systems enable the reversal of the power flow so that the local power may be injected into the electric power grid. However, in some cases, the electric power company refuses to accept power locally generated and requires assurances that power will not be injected which may cause overloads, frequency regulation problems and other issues.

While large electric power supply companies and power utility systems manage the source and distribution of electric power through the electric power grid, there is currently no standalone system of control units that may be integrated with a local or small scale power generation system to more effectively manage and control power distribution based on a comparison of costs, time of day, seasonal usage and other information from each power generation system and based on the electric company's tariff rules and pricing to determine optimal distribution of power and the actual costs and power usage efficiencies.

The control units of the prior art fail to provide control of power from the electric power grid to turn on power when local power supply reserves are low or not available and to shut down power from the electric power grid when local power is available thereby preventing the injection of power from the local power supply into the power grid.

Most control units of the prior art also provide consumption reports and other useful information to the customer. Some control units are able to transmit information over an internet connection if one is available. However, current control units are normally unable to take into account complex tariff rules and pricing per energy unit issued by the power company. This shortcoming prevents the control unit from being able to configure the system to take best advantage of tariff rules and pricing to produce detailed savings reports that list not only the amount of energy saved but also the total amount of money that these energy savings represent. Which means that if the customer wants to know the amount of money saved, the power production reports have to be collected from the electric power company and be compiled and post processed after consumption. However, the accurate calculation of actual cost savings requires power consumption information correctly associated with the time of power usage, including battery charge and discharge cycles and in many cases this is not possible due to inaccurate or missing time information. The present invention addresses the shortcomings of these power control units of the prior art and provides and easily integrated system that optimizes power usage based on availability and cost per unit energy to improve overall energy efficiency and power usage within a local power generation environment.

### SUMMARY OF THE INVENTION

A new interactive power management control system consisting of a main control unit, and one or more equipment control units such as solar control units, wind control units, engine generator control units, and/or other power generation control units and battery backup control units are described herein.

The power management control system allows information such as available power, power frequency, power phase and other measurements particular to each equipment control unit to be exchanged among the main control unit and the equipment control units, allowing the main control unit to determine at any time the optimum configuration for the available power generation equipment or to set a specific optimal power plan for distribution of power. The optimum configuration is based on information received from the equipment control units, recorded historical usage, peak hours, seasonal considerations, from other energy information resources such as weather forecasts that may affect wind and solar generator outputs and customer specific supply conditions such as contracted tariffs, minimum and maximum usage, and other information collected from the electric power supply company. All information regarding power supply conditions, including the customer specific terms and conditions in an electric supply contract that a customer may have with the power supply company are used to optimize and control the distribution of power from the electric power grid and from one or more power generation systems. In some embodiments, the power management control system may use information relating to requirements in an electric power supply company contract to control the distribution of power from the electric power grid to set and maintain minimum power usage from the electric power grid thereby adhering to purchasing requirements outlined within the contractual agreement. Using the power management system of the present invention, the minimum power usage requirement from the electric power grid may be set and maintained based on a numerical value or a percentage of the contracted supply of the customer which may be a fixed power usage minimum setting or may be variable power usage setting that may increase or decrease during the day and over the months of the year based on current available power capacity of the power grid and environmental conditions and other factors that may affect the power output from the power generation systems within the power management system. The power management system may further control the supply of excess power from the customer's power generation system back into the grid based on the contractual requirements stored and accessed wired and wireless transmission of date from the electric power supply company including updates of power generation conditions, available supply and costs that may affect or modify the contractual terms between the customer and the electric power supply company. For example, a blackout within the power grid, may provide for the power management system to transmit power back to the electric power grid to provide electric power locally based on the available power capacity of the customer's power generation system. The control of power using the power management system may further prevent the transmission of power from the customer's power generation system back to the electric grid based on these contractual requirements.

Each equipment control unit is configured using the power control software application of the present invention according to the power generation equipment that the equipment control unit is controlling by means of a set of configuration files that has all necessary parameters to properly control and gather information from the power generation equipment.

The main control unit system can be configured for use within a power generation system using the power management software application of the present invention. Access and setup of the main control unit and equipment control units may be through an administration module that can be used to create an administrator user level access and additional users of different categories, each category with particular rights so that access to reports, maintenance, the main control unit and the equipment control unit power management system configuration, user creation, and other functionalities can be granted only to users with appropriate administrative clearance.

The power management control system can be configured to work connected to the internet or be isolated depending on user convenience and safety requirements. A list of allowed and blocked functions determines what functions can be performed over the internet and by what user categories. This list may be edited only by an administrator level user.

In an embodiment, the main control unit is configured with a comprehensive set of information, including:
1. Files accessible through one or more computer connections using a local intranet connection or through a wired or wireless internet connection. The files detailing the cost of power from the electric power grid according to the supply conditions of the electric company. This file contains all relevant information such as installed maximum power supply, contracted monthly power consumption, cost of power at peak hours and off peak hours, power cost seasonal changes, surcharges for using more than the contracted power consumption, minimum required consumption (≧0) and maximum power that can be injected into the grid (≧0) as well and other information.
2. Configuration files accessible through one or more computer connections using a local intranet connection or through a wired or wireless internet connection for each available local or small scale power generator that provides pertinent information such as maximum emergency power, maximum continuous power, estimated cost of power generated, maximum continuous hours of operation per day, preventive maintenance requirements (such as replacement of filters or other component parts after certain hours of operation), and other specific information.
3. Files accessible through one or more computer connections using a local intranet connection or through a wired or wireless internet connection. The files detailing generation forecasts for solar, wind and other power supply generators with the power system providing hourly and daily values for expected maximum and average power output for each day of the year. The local or small scale power system uses the generation forecast and the actual power output at a given time to estimate the output of solar, wind and other generators during the next hour and the next 24 hours.
4. Configuration files accessible through one or more computer connections using a local intranet connection or through a wired or wireless internet connection for the battery backup equipment identifying the total energy capacity, maximum charge and discharge rate, minimum charge limit and other relevant parameters.
5. Files accessible through one or more computer connections using a local intranet connection or through a wired or wireless internet connection The files detailing a consumption forecast for the customer hourly and daily expected power requirements for each hour and day of the year. The power system uses the consumption forecast and the actual power consumption at a given time to estimate the power consumption during the next hour and the next 24 hours.

The main control unit for the local or small scale power generation system assigns priority to available power supply generators according to the cost of generated power at each generator and other information recorded within the generator's configuration file such as maximum continuous power, current available power capacity, downtime for maintenance, and environmental conditions. The main control unit also takes into account the cost of the electric company's power grid power following daily and seasonal variations according to the grid power configuration file to continually determine the best possible power configuration for the available power supply generators and battery backup unit.

From the power capacity and cost analysis and requirements set through contractual agreements with the electric power supply company, the main control unit may inject excess power from the local power supply generators to the electric power grid or prevent the injection of excess power and temporarily shut down the power connection to the power grid, instead directing excess power to the battery backup equipment. Furthermore, in cases where the electric power supply company imposes a strict rule of no injection of power from the customer's power generation system, the power management system of the present invention can be configured to prevent power from being injected to the electric power grid under any circumstances by setting a minimum usage variable to ensure that a minimum consumption of power from the electric power grid is always being supplied to the customer whenever the power grid is connected. The minimum usage variable may be set to an adequate threshold to prevent any injection of power from the customer's power generation system due to possible measurement errors or surges before the system can take appropriate measures. The minimum consumption of power using the minimum usage variable may also be set to a threshold based on and to adhere to any contractual requirements.

Through this unique feature of the present invention, the main control unit provides assurances to the electric company that there is no possibility that power from the local power generation system will be fed to the electric power grid and removes risk of overloads, frequency alterations and other supply issues.

An object of this invention is the determination and implementation by the power management control system of the optimum power configuration that will produce the best result of savings using the cost information, the estimated generated power, the estimated power consumption, the capacity and available power stored at the batteries, the actual power output and actual power consumption.

Another object of the invention is the ability of the power management control system to react to external events such as grid power outage, generator failure, consumption power surge, scheduled and unscheduled maintenance, and other power degradation issues and immediately reconfigure to the next best power configuration.

Another object of the present invention is the generation of reports for power consumption, power generated by each generator, battery status, cost savings and custom created reports. These reports are made available at the main control unit and if so programmed can be sent to a stored list of recipients over the internet.

Another object of the present invention is to route excess power from the local power generation system to the electric power grid and additionally or alternatively to battery backup systems.

Another object of the present invention is control by the power management control system to temporarily disconnect a local power generation system from the electric power grid or ensure a minimum consumption threshold higher than maximum possible measurement errors and surges to prevent the injection of power from the local power generation system into the electric power grid.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a perspective view of a first embodiment of a control unit of the present invention;

FIG. 2 is a diagrammatic view of a first embodiment of a power management control system used to configure and manage equipment installed locally at a customer site or small scale power generation system;

FIG. 3 is a flow diagram of an embodiment of the power management software application loaded into the main control unit of the present invention;

FIG. 4 is a flow diagram of an embodiment of the manage power sub-routine of the power management software application loaded into the main control unit of the present invention;

FIG. 5 is a flow diagram of an embodiment of the power control software application loaded into equipment control units such as solar control unit, wind control unit, engine generator control unit and battery backup control unit of the present invention;

FIG. 6 is a block diagram of an embodiment of modules of the power management software application implemented on the main control unit; and

FIG. 7 is a block diagram of an embodiment of modules of the power control software application implemented on the equipment control unit.

### DETAILED DESCRIPTION OF THE INVENTION

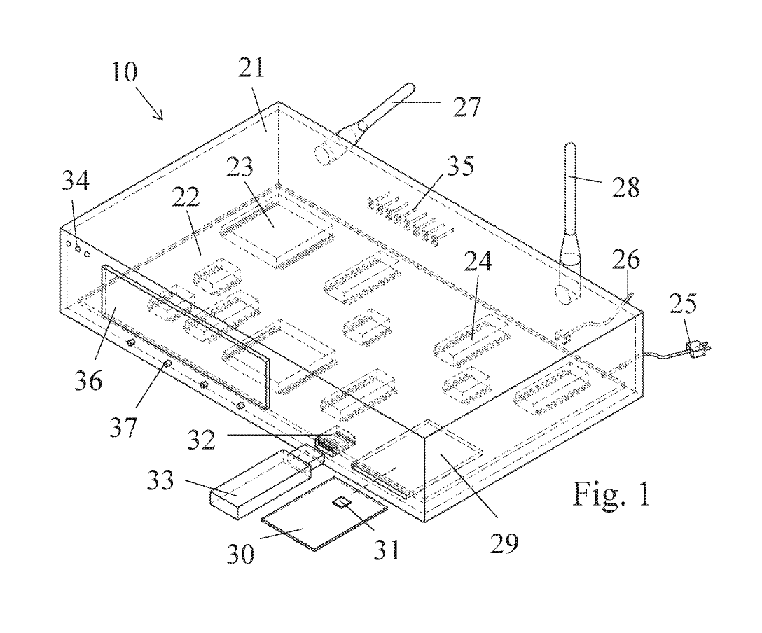

A main control unit 10 as shown in FIG. 1 is basically a custom digital device that has integrated circuitry constructed to be packed in a small box 21 that may be similar in size and shape to a decoder used in cable television operation. As a standalone device, the main control unit 10 contains an electronic mother board 22 with a microprocessor 23 and all necessary electronics 24 such as memory, input output interfaces, sensors, and other components. It operates with normal AC power 25 or battery power and has internet connections that may be using network cables 26 and/or wireless 27 means for transmitting and receiving data via a computer network such as Ethernet, Wi-Fi, Bluetooth. It can communicate with other equipment control units using the AC mains 25, internet network cables 26, wireless internet 27 or a FDM (frequency division multiplex) wireless interface 28. The main control unit 10 may have a slot 29 for a smart customer card 30 containing an electronic chip 31 to be inserted allowing for the identification of the customer and/or a USB interface 32 to cable or memory sticks 33 enabling information to be easily extracted and inserted into the system. It also has indicative lights 34 for power, communication and general alarm to enable the user to easily get critical information and react accordingly. General purpose analog and digital interfaces 35 are available to allow the main control unit 10 to interface to other equipment that may already be installed at the site or that may be installed in the future. An LCD Display 36, or other type of display such as a touch screen is available to allow information to be displayed locally such as voltage, current, operation time, and other related information. A number of buttons 37, using a touch screen or other user interface allow the user to make inputs into the system or to select different options to display information.

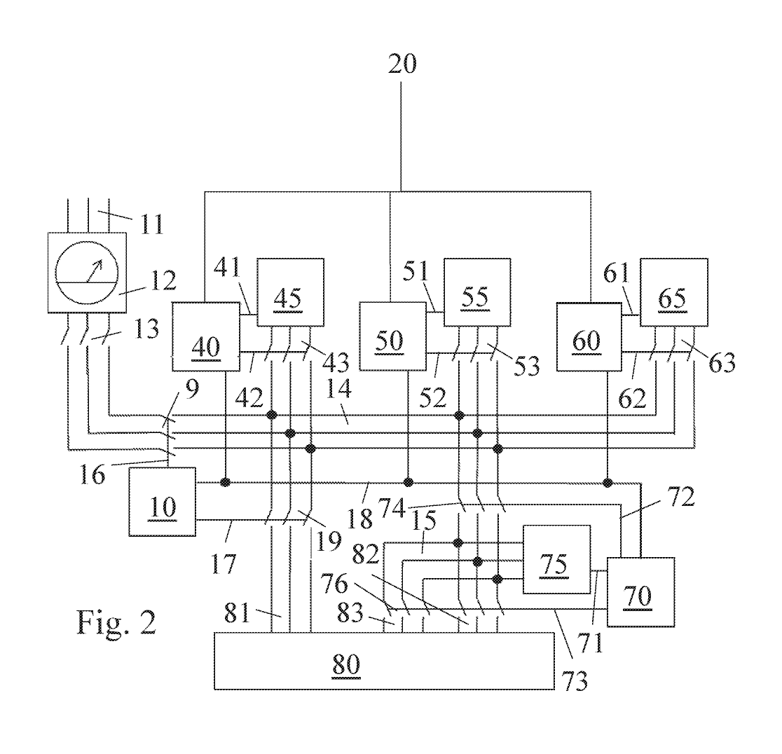

Other equipment control units 20, such as a solar control unit 40, a wind control unit 50, a diesel generator control unit 60 and a battery backup control unit 70, as shown in FIG. 2, can be made with the same hardware as the main control unit 10 by changing a configuration file so that the unit assumes a different role in the power generation system as intended or with slightly different hardware, made out of the same base computer circuitry, integrated electrical circuitry and hardware components but that does not have some of the features of the main control unit 10 such as for example the slot 29 for a smart card. The equipment control unit 20 may have a different amount of internal memory, more analog or digital interfaces, and other features specific to the power supply generator and the power management system requirements.

Having a single component and hardware platform tends to be more attractive since volume savings and the flexibility for supply and maintenance that a single universal unit provides compensates for having some redundant features in one and in other units in the system. To avoid confusion or the possibility of incorrect set up the main control unit 10 or an equipment unit 20, the LCD display 36, touch screen or other type of display can be made to show what type of unit has been configured and labeling on packaging, color or other indicators on a particular control unit box may be provided.

FIG. 2 shows a typical implementation of a power management control system. Electrical power from the power grid 11 supplied by the electricity company arrives at the customer and flows through a meter 12 so that the amount of energy consumed as well as the maximum instantaneous power can be measured. There is also a master circuit breaker 13 to disconnect the customer from the electric power grid 11. The power utility company normally has well established standards for the meter 12 and circuit breakers 13 and do not allow any modifications to be made or equipment to be installed that would alter the operation of the equipment at this point.

After the main circuit breaker 13, the main power line 14 is used to connect the solar equipment 45, wind generator 55, engine generator 65 and battery backup equipment 75 to the customer equipment 80 over an unprotected connection 81. A protected power line 15 is provided to connect the battery backup equipment 75 to the customer equipment over a priority protected connection 82 and normal protected connection 83.

The main control unit 10 collects information such as voltage and current and controls circuit breakers 9 that can disconnect the unprotected power line 14 from the power grid 11 through control lines 16. The main control unit 10 also collects information such as voltage and current and controls circuit breakers 19 that control the switching of power to customer equipment 80 through unprotected connection 81 through additional control lines 17.

The main control unit 10, solar control unit 40, wind control unit 50, engine generator control unit 60 and the battery backup control unit 70 exchange information over a data connection 18.

The solar equipment 45 is controlled by the solar control unit 40 by means of several analog and digital solar control lines 41. The solar control unit 40 collects data from the solar equipment 45 and transmits commands back to the solar equipment 45. The solar control unit 40 collects information such as voltage and current and controls circuit breakers 43 that can disconnect the solar equipment 45 from the unprotected power line 14 through solar control lines 42.

The wind generator 55 is controlled by the wind control unit 50 by means of several analog and digital wind control lines 51. The wind control unit 50 collects data from the wind generator 55 and transmits commands back to the wind generator 55. The wind control unit 50 collects information such as voltage and current and controls circuit breakers 53 that can disconnect the wind equipment 55 from the unprotected power line 14 through wind control lines 52.

The engine generator 65 that may be diesel engines or similar equipment is controlled by the engine generator control unit 60 by means of several analog and digital engine generator control lines 61. The engine generator control unit 60 collects data from the engine generator equipment 65 and transmits commands back to the engine generator equipment 65. The engine generator control unit 60 collects information such as voltage and current and controls circuit breakers 63 that can disconnect the engine generator equipment 65 from the unprotected power line 14 through engine generator control lines 62.

The battery backup equipment 75 is controlled by the battery backup control unit 70 by means of several analog and digital battery backup control lines 71. The battery backup control unit 70 collects data from the battery backup equipment 75 and transmits commands back to the battery backup equipment 75. The battery backup control unit 70 collects information such as voltage, current, and storage capacity and controls circuit breakers 74 that can disconnect the battery backup equipment 75 from the unprotected power line 14 through battery backup control lines 72. The battery backup control unit 70 also controls the circuit breakers 76 that control the switching of customer equipment 80 through priority protected connection 82 and normal protected connection 83 through battery backup additional control lines 73.

### Configuration and Operation of the Units and System

Specific power management software application that is written to be accessible and run on the main control unit 10, the equipment control units 20, other system components such as circuit breakers and switches to change and re-route power flow as determined through the power capacity and cost analysis. The power management software application may also be accessible using a digital device such as a computer, an iPod, iPad, tablet computer, notebook, laptop, smart phone, cell phone or other devices that may be used as a processing unit, a display unit, and/or a unit to give processing instructions to communicate to and from the main control unit 10, the equipment control units 20 and other system components such as circuit breakers and switches. The implementation of the power management software application on the control units 10 and 20 and on other digital devices provides for advanced features to be accessible by the user such as the ability to graphically display power usage and cost information, to audit and change configuration information to the power generation equipment and equipment control units 20 or to perform other operations that optimize power usage for the customer. The LCD display device 36, touch screen or other display provides visually to the user transactional data that has been subject to transformations using the power management software application 120 of the present invention implemented on computer circuitry of the main control unit or the equipment control units 20. The display device 36 can be a monitor, a tablet computer, or other visual computer screen or graphical user interface (GUI), a printer or other digital device that provides a visual or other type representation of a final output from the microprocessor-based unit 23. The display device 36 can also be an output device that provides the transactional data as a digital file. The microprocessor-based unit 23 provides means for processing the transactional data to produce readily discernible, informational and organized images and data on the intended output display device 36 or media.

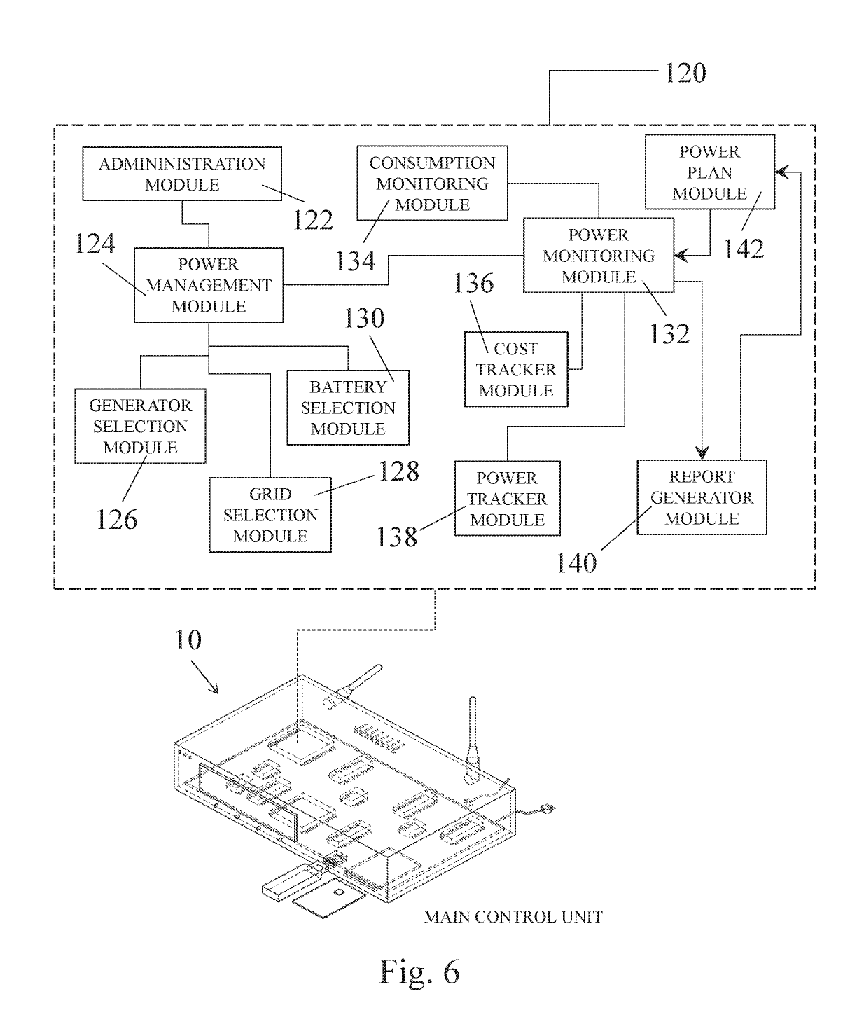

To improve safety, the main control unit 10 using an administration module 122 of the power management software application 120 as shown in FIG. 6, has an access system requiring a user name and password to allow or restrict access to certain functions. The users have different categories and privileges in a similar way to modern computers and the system will report any failed login attempt to the administrator and other users upon their next successful login. Additional safety measures are also in place such as data encryption, a configurable time delay until the next possible login attempt after each unsuccessful login attempt to prevent brute force attacks, an alarm light that will be lit in a easily visible location at the main control unit 10 in case any unsuccessful login attempt has occurred until it is acknowledged and cleared by a route level administrator or user with this privilege.

The main control unit 10 comes from the factory with a root administrator user pre-configured with a default password. Upon first use this administrator user will be used to configure additional users of different categories such as administrator, management, user, guest, etc. with each category having their particular privileges and access to different functions of the system.

The root administrator should only be used by qualified personnel and preferably only for system configuration, upgrades and changes. For safety it is recommended that only one person has access to the root administrator user and the factory default route user password be changed as soon as possible for security.

A user can only apply changes to configurations created by users of the same level or below so no user can change a configuration created by the route user. This can be useful to prevent undesired changes to the power management system done by accident or on purpose.

This hierarchy of users with the highest level being the root administrator provides a platform that can also be used as a means to establish a business. For example, a company can purchase some or all equipment, set up and install a local energy generation power plant for another company. The receiving company is given levels of access only at a regular administrator level, management level, user level and guest level but not access to the root administrator level. The company owning the system can then setup a management system with configuration settings allowing for energy savings to be accurately measured and translated into actual monetary savings and for reports to be sent over the internet to its headquarters. The company receiving the equipment would then be charged a percentage of these savings as agreed in a contract. The company receiving the system is benefited by being able to save on electricity costs without the need to invest money upfront to pay for equipment and instead pays the monthly fees with savings it has already made. At the same time it also benefits from the additional functionalities the power management system provides, such as better management of power usage within the company, detailed consumption and savings reports, increased power safety, and full control to inject excess power to the power grid if allowed by the electricity company or a temporary disconnection from the power grid to re-route excess power to a battery backup system for use during power outages or low availability of power from the power grid or the local power generation system. The company owning the power generation equipment can create different power generation packages depending on what services such as the amount renewal energy accessible by the customer and maintenance and charge separately for these services. Many other possible agreements can be made.

If the customer defaults with the payments, the company owning the equipment can remotely send a command for example over the internet disabling the power generation equipment forcing the customer to rely only on its own power generation equipment if available and/or on power from the electric company's power grid, eliminating any savings that could otherwise be obtained. Within the power management system, system safeguards can prevent the customer from disconnecting or otherwise disrupting the transmission of commands to the power generation equipment or tampering with an internet connection available to the equipment. If the internet connection is physically disconnected, after a preset time with no interim internet connection such as over a period of 30 days, the affected power generation equipment, main control unit 10 and equipment control units 20 would automatically be disabled. The settings to disable components within the power generation system is set up and controlled through a high level administrator given privileges through the administration module 122 of the power management software application 120 implemented on the main control unit 10. The company receiving the power generation system does not have access to this administrative level, and the receiving company will not be able to change the disabled configuration. Any failed attempt to log in as a high level administrator can be blocked and can generate a message notifying the company owning the power generation equipment of tampering attempts.

In this way a company can enter a business of leasing power generation equipment that can be used to generate electricity savings and share with the company receiving the power management system the financial result coming from the power savings.

As default, any unit is configured as a main control unit 10. A user with root administrator or administrator privilege can modify the main control unit 10 to become an equipment control unit 20 by providing the necessary configuration information and then the information concerning the power generation equipment to modify the unit to an equipment control unit 20 once the unit is connected to the power generation equipment.

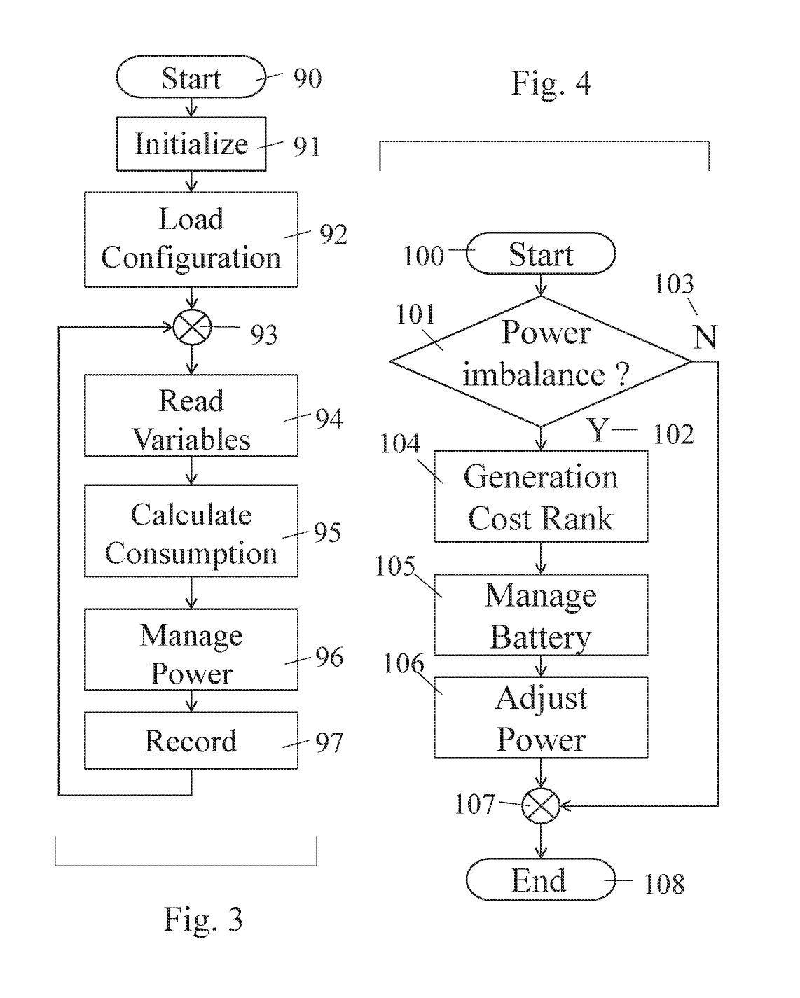

The operation of the main control unit 10 is controlled by the control unit power management software application 120. FIG. 3 shows one embodiment of the basic procedural steps of the control unit power management software application 120. Upon Power up of the main control unit 10 or of an equipment control unit 20, the power management software application 120 starts to run 90, initialize itself 91 and load the configuration file 92 to determine what the control unit is expected to do. In the case where no configuration file is loaded the software application 120 assumes the default operation of the main control unit 10 and waits for configuration. When a control unit set of configuration files is correctly loaded, the software application 120 continues to the normal operation part 93.

The set of configuration files for the main control unit 10 contains:
1. A system configuration file, that assigns the current unit as a main control unit 10 and lists all the equipment control units 20 configured into the power management system;
2. An equipment configuration file that lists technical data such as type of power generation equipment, maximum output power, maximum continuous output power, maintenance schedule, and other equipment specific information based on the type of power generation equipment for the power supply generator equipment controlled by each of the equipment control units 20 referred to in the system configuration file;
3. A cost configuration file that lists the cost of generating energy from each of the power supply generators listed in the equipment configuration file and the cost of the grid power as determined by the electricity power company. Data may be collected and compiled from the power supply generators within the power management system and comparisons to external sources noting energy costs may be used to determine the kilowatt/hour cost for each type of power generator at any specific point in time or to determine average costs over any period of time, such as on a daily or weekly basis.

Next the control unit power management software application 120 reads all input variables 94 such as voltages and currents provided from each equipment control unit 20 for each power generator within the power management system. The input variables may be transmitted to the main control unit 10 through a direct connection to the main control unit 10 using an analog or digital interface and these variables 94 may be sampled first and the other variables 94 transmitted from the equipment control units 20 listed in the system configuration file may be obtained through the data connection 18 which may be a wireless connection.

The power management software application 120 then calculates the current consumption 95 of the customer equipment 80 and the amount of available power generation as provided by the information collected from the equipment control units 20.

The main control unit 10 then manages the distribution of power from the power generation equipment through transmitting commands and receiving data from the equipment control units 20 to increase or decrease power output and by controlling circuit breakers and switches within the power management system to allocate power from the power generation equipment and from the power grid 96 to minimize energy costs for the customer. The manage power routine is shown in greater detail in FIG. 4.

The manage power routine start 100 and the power management software application 120 determines if the current power needs of the customer have been increased or have been reduced over a preset period of time. If one of the power supply generators generation capability has changed or if the cost structure of the power from the electric power grid 11 has changed since a last periodic assessment, a power imbalance flag is set by either the main control unit 10 or by the equipment control unit 20 controlling the affected generator. The power management software application 120 runs a status check for the power imbalance flag 101 and if it is set 102, the power management software application 120 determines the cost of power generated at each generator and runs a comparison to the cost of power from the electric company's power grid 11 and ranks the power supply generators and the power grid by power costs 104. If the power management software application 120 determines a power generator is at a lower cost than the power grid, the main control unit 10 implements a command to components within the power management system such as circuit breakers 9 to shut down power from the electric power grid 11 and provide power from the generator that provides the cheapest cost to supply power to the customer. Further, commands to the equipment control units 20 and components within the power management system shut down power from the other power supply generators unless the maximum continuous power provided by the cheapest generator is insufficient to supply the customer requirements, in which case the power management software application 120 assigns the maximum continuous power to the cheapest generator and deducts this calculated power from the customer required power and proceeds to command the next cheapest power supply generator to supply power until the power requirements are met or the generation cost of the next generator is equal to or greater than the current cost of energy from the electric company's electric power grid 11.

In further embodiments, and where the customer allows that option, the power management software application 120 manages the battery backup control unit 105 so that the battery backup equipment 75 is used to supply power during the peak hours when the customer equipment 80 requires more power than the installed generators are able to produce when the power is cheaper than the cost of electricity from the power grid. The power management software application 120 controls the charging of the batteries so that they are scheduled to be recharged at a later time when the customer power requirements have reduced and the power supply generators are able to provide power to supply the expected customer requirements and recharge the batteries or provide power from the electric power grid when the electricity costs are the lowest during the 24 h period. At the time the battery backup equipment 75 is expected to be recharged, the main control unit 10 selects what generator can do the job or resort to the grid power following a similar method to determine the optimum arrangement and minimal costs to recharge the battery backup equipment 75 at the same time it manages power to be supplied for the customer requirements.

In cases where the contract with the electricity company allows and the installed power supply generators are able to produce surplus power at an economically viable cost, the power management software application 120 calculates the output of the generators to produce the power that will be allowed to be sent back to the power grid 11. If the power management software application 120 determines the battery backup system 75 is fully charged and that the maximum continuous power provided by the cheapest generator is sufficient to supply the customer requirements or with one or more other power supply generators there is a surplus of power, the power management software application 120 of the main control unit 10 issues commands to direct power to the power grid 11. If the customer power requirements increase reducing available surplus power, the power management software application 120 issues commands to adjust the power 106 supplied to the customer equipment 80 by shutting down the power supply to the power grid 11 and signaling the equipment control units 20 to increase the power supplied from the other power generators if using the power capacity and cost analysis, power from the power supply generators is cheaper than power from the power grid 11. In cases where there is not an agreement allowing excess power to be provided to the power grid 11 or in the case where there are fines to the customer if power is injected to the power grid 11 due to overloads and frequency regulation issues, the main control unit 10 guarantees that excess power from the power supply generators does not enter the power grid 11 by issuing commands to isolate the power management system and power supply generators from the power grid 11. The main control unit 10 may issue commands to circuit breakers 43, 53, or 63 at the power supply generators, to circuit breaker 74 for the battery backup or to circuit breaker 9 to prevent power from being supplied to the power grid 11. Power is directed to the customer equipment 80 and excess power is directed to the battery backup 75. By completely isolating the power supply generators using the power management system, the risks of fines to the customer for supplying power to the power grid 11 is removed. Additionally, in some embodiments, whenever the circuit breaker 9 is closed allowing the connection to the power grid 11, the main control unit 10 issues commands to the power supply generators and to the battery backup based on a pre-programmed minimum usage variable that sets a minimum power usage threshold, meaning that at least the pre-programmed minimal amount of power is flowing from the electric power grid 11 into the customer equipment 80 so that even in case of measurement errors or surges, no power is supplied to the power grid 11 at any time. The minimum power usage variable may also be set by a contractual agreement between the customer of the electric power supply company.

In case number 103 if power imbalance is not detected at a particular loop, the power management software application 120 diverts 107 to the end 108 of the manage power routine.

In FIG. 3 after the manage power routine 96, the power management software application 120 continues to record 97 the power generated at each power supply generator, the power consumed by the customer equipment 80 and all variables that are relevant to produce detailed reports of consumption, costs, energy efficiency, and other important information related to the power generation equipment.

The software then branches back to normal operation at part 93 to read variables and re-access the situation so that the power can be continually monitored and controlled at very short intervals and ensure that consistent and safe power is supplied to the customer.

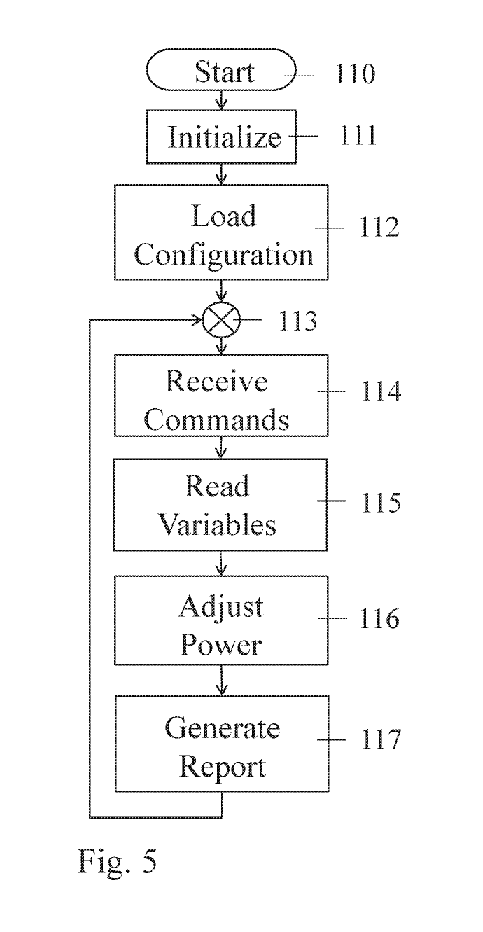

FIG. 5 shows one embodiment of basic procedural steps of the equipment control unit 20 using the power control software application 150 that is installed and operational on the equipment control units 20 and that may be accessible on other digital devices through a wired or wireless connection. Upon Power up the power control software application 150 starts to run 100, initialize itself 111 and load the configuration file 112 to determine what it is expected to do. When the configuration file is loaded the power control software application 150 assumes the default operation of the equipment control unit 20 and waits for configuration. If an equipment control unit set of configuration files is correctly loaded the software continues to the normal operation part 113.

The set of configuration files for the equipment control unit 20 contains:
1. A system configuration file, that assigns the current unit to be of a particular type such as a solar control unit, wind control unit, engine generator control unit or battery backup control unit or other type of power supply generator as specified in an equipment configuration file. The system configuration file lists the main control unit 10 and all equipment control units 20 configured into the power management system;
2. An equipment configuration file that lists technical data such as maximum output power, maximum continuous output power, maintenance schedule, and related equipment information for the power generation equipment controlled by the equipment control unit 20;
3. A cost configuration file that lists the cost of generating energy from the power generation equipment controlled by the equipment control unit 20.

Next the power control software application 150 checks for received commands 114 through the data connection and reads all input variables 115 such as voltages and currents under its responsibility as defined in the configuration files.

The power control software application 150 then implements the received commands to adjust power 116 of the power generation equipment it controls and reports 117 the equipment status back to the main control unit 10, sending all information it is instructed to report in the configuration file such as voltages, currents, alarms, operational status and other specific equipment related information.

The power control software application 150 then branches back 113 to repeat the control cycle so that the power from the power generator equipment can be controlled at very short intervals and ensure that consistent and safe power is supplied to the customer equipment 80.

As shown in FIG. 6, the power management software application 120 implemented on the main control unit 10 comprises modules that monitor and control the distribution of power and provide reports of actual power output, consumption, and costs, optimizing the efficiency of the power generation system. The power management software application 120 comprises an administration module 122 that sets privileges for users, restricting access to users based on these privilege settings. A power management module 124 controls the distribution of power through modules that include a generator selection module 126 controlling power available from the equipment control units 20, a grid selection module 128 controlling power from the electric power grid 11, and a battery selection module 130 controlling power to the battery control unit 70. The power management module 124 controls the contribution of power from the power supply generators within the power generation system, the power grid 11 from the electric company, and the battery backup equipment 75 through real-time analysis of data provided from a power monitoring module 132 of the power management software application 120.

The real-time analysis of the power monitoring module 132 uniquely transforms data received from a consumption monitoring module 134, a cost tracker module 136 and a power tracker module 138. The consumption monitoring module 134 measures the consumption of power at the customer's site. A cost tracker module 136 receives through an interne connection data on energy per unit time pricing for power received from the electric company through the electric power grid 11 and receives data from the equipment control units 20 on costs of energy per unit time for the specific type of power supply generator. A power tracker module 138 receives power capacity data and other information from each equipment control unit 20 within the power generation system. The power monitoring module 132 correlates and transforms data received from the power consumption module 134, the cost tracker module 136 and the power tracker module 138 and issues triggers and alarms to the power management module 124 if capacity from any generator is exceeded by consumption and/or the costs of energy per unit time from one generator exceeds the costs from energy from the power grid 11. The power monitoring module 132 may further provide alarms if excess capacity beyond consumption requirements is available from any power generator providing for the main control unit 10 to distribute energy to the battery backup equipment for recharging using the battery selection module 130.

The continual tracking and real-time data provided by the power monitoring module 132 provides for data on cost, power consumption, and power capacity to be transmitted to a report generator 140. The report generator 140 uses this data to generate specific usage reports that include at what time of day power switching occurs, the capacity of each power supply generator and the power grid 11 when power switching occurs, the costs of power generation and the cost savings realized at any point in time of using the power generation system. From the transformed data and analysis performed by the power management software application 120, the report generator 140 may also create specific power distribution plans using a power plan module 142 to optimize energy usage based on previous consumption requirements, peak usage during the time of day, seasonal requirements, and other information to more efficiently control the power generation system and if allowed provide power back to the electric power grid 11 during peak hours when other customers connected to the electric power grid 11 have high power consumption.

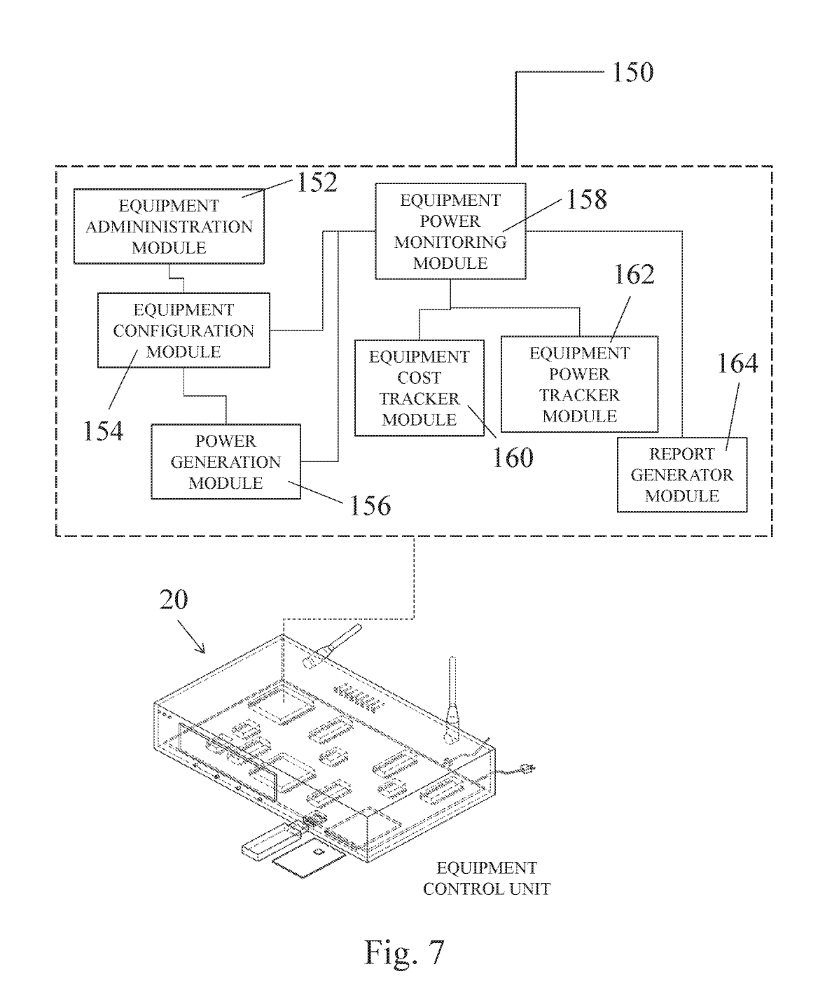

As shown in FIG. 7, the equipment control unit 20 implements the power control software application 150 to control power output and monitor power capacity and information from the power supply generators. The power control software application 150 has an equipment administration module 152 that controls user access to the equipment control unit 20 and an equipment configuration module 154 that configures the equipment control unit 20 to the specific power generator that is being controlled, such as a solar power generator 45, a wind power generator 55, a diesel power generator 65 or other power generation equipment. The power generation module 156 of the equipment control unit 20 receives commands from the main control unit 10 to supply power or stop supplying power based on the power management software 120 analysis of cost, capacity and consumption requirements. The power management software 120 uses data transmitted from the equipment power monitoring module 158 of the equipment control units 20. The equipment power monitoring module 158 transforms data generated from an equipment cost tracker module 160 and an equipment power tracker module 162. The equipment cost tracker module 160 may accept data related to costs specific to the type of power generation equipment through an internet connection to provide real time costs of energy per unit time. This information is provided to the power monitoring module 158 with data from the power tracker module 162. The power tracker module 162 provides data from measured voltage, current, power usage, maximum and minimum power output of the power supply generator and other information specific to the power supply generator. The equipment power monitoring module 158 may continually transmit data to the main control unit 10 that includes power generation, transmission and capacity available from the power supply generator at any point in time. The equipment power monitoring module 158 also stores and transmits data to an equipment report generator 164 to produce summaries of collected data from the power generator that may include the power transmission when and for how long a period of time, the available capacity, the cost of energy per unit time, and the specific time points where the power generator is turned on and off. The main control unit 10 uses the real-time data collected and stored from each equipment control unit 20 to optimize power usage within a local or small scale power generation system. The report generator 140 of the power management software application 120 produces summaries of collected data from the equipment control units 20 for each power supply generator that may include the power transmission of each including when and for how long a period of time the power supply generator is supplying power, the available capacity and the cost of energy per unit time of each power supply generator, the power supplied from each generator to the electric power grid 11, and the specific time points when each power supply generator is turned on and off based on costs compared to the pricing of power from the electric power grid 11 and the use of battery power from the battery backup equipment 75. From the optimization and analysis provided by the power management control system the customer is provided with the actual cost savings in real-time while using the power generation system, information that is not currently available using the manufacturer specific control units.

Since certain changes may be made in the above-described invention, without departing from the spirit and scope of the invention herein involved, it is intended that all of the subject matter of the above description or shown in the accompanying drawings shall be interpreted merely as examples illustrating the inventive concept herein and shall not be construed as limiting the invention.

What is claimed is:

1. A power management control system comprising:
a main control unit;
a plurality of equipment control units having integrated circuitry to connect to the main control unit over a data connection and to interface each one of the plurality of equipment control units to one of a plurality of power supply generators.

2. The power management control system of claim 1 wherein the main control unit comprising a power management module to operationally control the plurality of equipment control units within a programmable network simultaneously to manage the distribution of power from the plurality of power supply generators within a power generation system.

3. The power management control system of claim 2 wherein the power management module comprising:
a generator selection module;
a grid selection module;
a battery selection module; and
wherein the power management module controls the contribution of power from the plurality of power supply generators, the electric power grid and the battery.

4. The power management control system of claim 3 wherein the main control unit comprising a power monitoring module; and
wherein the power management module controls the contribution of power from the plurality of power supply generators, the electric power grid and the battery using the power monitoring module that performs a real-time analysis of power consumption, power cost and power capacity.

5. The power management control system of claim 4 wherein the power monitoring module comprising:
a consumption monitoring module measuring consumption of power at a customer's site;
a cost tracker module receiving cost of energy per unit time through an internet connection for power received from the electric power grid and cost of energy per unit time for power from each one of the plurality of power supply generators;
a power tracker module receiving power capacity data from each one of the plurality of equipment control units interfaced with each one of the plurality of power supply generators; and
wherein the power monitoring module determines the real-time cost of power from the power supply generators.

6. The power management control system of claim 5 wherein the power management module optimizes energy usage by selecting to supply power based on which one of the plurality of power supply generators, the electric power grid or the battery has the lowest cost of energy per unit time.

7. The power management control system of claim 6 wherein the power management module injects power from at least one of the power supply generators to the electric power grid.

8. The power management control system of claim 6 wherein the power management module temporarily disconnects the power generation system from the electric power grid to prevent power from the power generation system from being injected to the electric power grid.

9. The power management control system of claim 2 wherein the power management module uses a minimum power usage variable to set a threshold to ensure a minimum consumption of power from the electric power grid when the power generation system is connected to the electric power grid.

10. The power management control system of claim 5 wherein the main control unit comprising a report generator to generate usage reports comprising:
capacity of each one of the plurality of power supply generators;
time when any switching of power occurs;
cost of energy per unit time;
costs of power generation; and
cost savings realized at any point in time.

11. The power management control system of claim 10 wherein the main control unit comprising a power plan module to implement configurable power plans from data compiled using the report generator to control the supply of power according to one of at least the available capacity of each one of the plurality of power supply generators, the cost of energy per unit time, the peak usage during the time of day, the season of the year, the available power in the case of a power outage and user comfort and safety in order to maximize energy savings.

12. The power management control system of claim 2 wherein the main control unit comprising an administration module to simultaneously reduce or disable power output from one or more of the plurality of power supply generators within the programmable network for non-payment of fees.

13. The power management control system of claim 1 wherein each one of the plurality of equipment control units comprising:
an administration module;
an equipment configuration module;
a power generation module;
a power monitoring module; and
equipment report generator.

14. The power management control system of claim 13 wherein the equipment configuration module configures each one of the plurality of equipment control units to a specific one of the plurality of power supply generators to control and collect data from that specific power supply generator.

15. The power management control system of claim 14 wherein the power generation module controls the supply of power from the specific power supply generator being controlled based on commands from the main control unit.

16. The power management control system of claim 14 wherein the power monitoring module of the equipment control unit comprising:
a cost tracker module receiving cost of energy per unit time through an internet connection for the specific power supply generator being controlled;
a power tracker module measuring one of at least voltage, current, power usage, maximum and minimum power output and information related to the specific power supply generator being controlled.

17. The power management control system of claim 16 wherein the equipment report generator compiles data from the specific power supply generator being controlled, the data comprising when and for how long a period of time there is power transmission, the available capacity, the cost of energy per unit time, and the specific time points when power transmission is turned on and off

18. The power management control system of claim 1 comprising a management system that allows a third party to fully utilize the power management control system while the management system retains operational control of the main control unit and equipment control units within the power management system to, if necessary ensure payment by overriding users commands and settings to reduce performance or disable power from at least one of the plurality of power supply generators.

19. A computer readable medium of instructions for power management of a power generation system comprising:
instructions for configuring a plurality of equipment control units to have each one of the plurality of equipment control units control and collect data from one of a plurality of power supply generators within a power generation system;
instructions for configuring a main control unit to transmit commands to and receive data from the plurality of equipment control units;
instructions for configuring the main control unit to control the supply of power to a customer site receiving power from an electric company's power grid and from the power generation system;
instructions for determining the cost of energy per unit time supplied from the electric company's power grid to the customer site;
instructions for determining the cost of energy per unit time supplied from each one of the plurality power supply generators to the customer site;
instructions for controlling the contribution of power from each one of the plurality of power supply generators and the electric power grid based on the determination of which one of the plurality of power supply generators and the electric power grid has the lowest cost of energy per unit time.

20. The computer readable medium of instructions for power management of a power generation system of claim 19 comprising:
instructions for determining the power consumption requirements of the customer site receiving power from the electric company's power grid and from the power generation system;
instructions for determining the available power capacity of each one of the plurality of power supply generators;
instructions to supply power based on the capacity of which one of the plurality of the power supply generators having the lowest cost of energy per unit time and if the capacity is insufficient to meet the power consumption requirements then instructions to supply power from the next one of the plurality of power supply generators or the electric power grid having the next lowest cost of energy per unit time and instructions to combine power from the plurality of power supply generators and electric power grid until power consumption requirements are met.

21. The computer readable medium of instructions for power management of a power generation system of claim 20 comprising instructions for directing power from the power generation system to the electric power grid based on excess capacity from the power generation system.

22. The computer readable medium of instructions for power management of a power generation system of claim 19 comprising instructions for temporarily disconnecting the electric power grid from the power generation system to prevent the injection of power to the electric power grid.

23. The computer readable medium of instructions for power management of a power generation system of claim 19 comprising instructions to set a minimum power usage threshold to ensure a minimum consumption of power from the electric power grid when the power generation system is connected to the electric power grid.

24. A method of managing the distribution of power within a power generation system comprising:
configuring a plurality of equipment control units to have each one of the plurality of equipment control units control and collect data from one of a plurality of power supply generators within a power generation system;
configuring a main control unit to transmit commands to and receive data from the plurality of equipment control units;
configuring the main control unit to control the supply of power to a customer site receiving power from an electric company's power grid and from the power generation system;
determining the cost of energy per unit time supplied from the electric company's power grid to the customer site;
determining the cost of energy per unit time supplied from each one of the plurality of power supply generators to the customer site;
controlling the contribution of power from each one of the plurality of power supply generators and the electric power grid based on the determination of which one of the plurality of power supply generators and electric power grid has the lowest cost of energy per unit time.

25. The method of managing the distribution of power within a power generation system of claim 24 comprising:
determining the power consumption requirements of the customer site receiving power from an electric company's power grid and from the power generation system;
determining the available power capacity of each one of the plurality of power supply generators;
controlling the contribution of power from each one of the plurality of power supply generators and the electric power grid based on the capacity of each one of the plurality of power supply generators having the lowest cost of energy per unit time and if the capacity is insufficient to meet the power consumption requirements then instructions to supply power from the next one of the plurality of power supply generators or the electric power grid having the next lowest cost of energy per unit time and combining power from each one of the plurality of power supply generators and electric power grid until power consumption requirements are met.

26. The method of managing the distribution of power within a power generation system of claim 25 comprising directing power from the power generation system to the electric power grid based on excess capacity from the power generation system.

27. The method of managing the distribution of power within a power generation system of claim 24 comprising temporarily disconnecting the electric power grid from the power generation system to prevent the injection of power to the electric power grid.

28. The method of managing the distribution of power within a power generation system of claim 24 comprising setting a minimum power usage threshold to ensure a minimum consumption of power from the electric power grid when the power generation system is connected to the electric power grid.
